(19) United States
(12) Patent Application Publication
(10) Pub. No.: US 2023/0094069 A1
(43) Pub. Date: Mar. 30, 2023

(54) TOILET EQUIPMENT

(71) Applicant: Siu Tung LUI, Tsuen Wan West (HK)

(72) Inventor: Siu Tung LUI, Tsuen Wan West (HK)

(21) Appl. No.: 17/956,171

(22) Filed: Sep. 29, 2022

(30) Foreign Application Priority Data
Sep. 29, 2021 (HK) 32021039781.8

(51) Int. Cl. E03D 9/052

(52) U.S. Cl. CPC E03D 9/052

(57) ABSTRACT

A toilet equipment includes a main body provided with a dirt-holding cavity for collecting excrement; a flushing assembly arranged in the main body of the equipment for flushing the dirt-holding cavity; and a suction assembly including a suction pipe provided with an air inlet and an air outlet, a filter arranged between the air inlet and the air outlet, and a negative pressure source connected to the main body of the equipment and configured to provide airflow from the air inlet into the suction pipe. The air inlet is used to inhale the air into the dirt-holding cavity under the action of the airflow of the negative pressure source. In the above manner, the embodiments of the present utility model can effectively improve the situation that the aerosol formed during the flushing process of the toilet equipment is likely to exist in the area of the dirt-holding cavity.

### FIELD OF THE UTILITY MODEL

The embodiments of the present utility model relate to the technical field of toilet equipment, in particular to a toilet equipment.

### BACKGROUND OF THE UTILITY MODEL

In modern life living, the toilet has become one of the indispensable toilet equipment in people's daily life. With the continuous improvement of economic development and living standards, people's requirements for toilets get higher, and the toilets have been continuously improved during usage and equipped with many special functions, such as seat ring insulation, warm air drying, automatic deodorization, silent seating, etc.

But the inventors found that: in order to flush the excrement clean, the existing toilets generally use a relatively high-pressure water flow to flush the dirt-holding cavity. However, it is ignored that the toilet equipment forms aerosols mixed with tiny particles of excrement during the flushing process. The aerosol can sustain in the area of the dirt-holding cavity stably and for a long time, and that will cause the spreading of fungi or viruses.

### SUMMARY OF THE UTILITY MODEL

The embodiment of the present utility model provides a toilet equipment to improve the situation that the aerosol formed during the flushing process of the toilet equipment is likely to exist in the area of the dirt-holding cavity.

The main technical problem solved by the embodiments of the present utility model is to provide a toilet equipment, comprising a main body, is provided with a dirt-holding cavity for collecting excrement; a flushing assembly, is arranged in the device body for flushing the dirt-holding chamber; and a suction assembly, includes a suction pipe, a filter and a negative pressure source; the suction pipe is provided with an air inlet and an air outlet, the air inlet is a slit, the filter is arranged between the air inlet and the air outlet, and the negative pressure source is connected to the main body; the negative pressure source is configured to provide airflow from the air inlet into the suction pipe, and the air inlet inhales the air in the dirt-holding cavity by the airflow of the negative pressure source.

In some optional embodiments, the suction assembly includes a first shell and a second shell; the first shell is connected to the main body, and is located at the opening of the dirt-holding cavity; the second shell is rotatably connected to the first shell, and the second shell is set a first rotating state and a second rotating state relative to the first shell; the second shell rotates to the first rotating state to close the opening of the dirt-holding chamber and rotate to the second rotation state to open the opening of the dirt-holding cavity; the suction pipe and the negative pressure source are both arranged in the first shell, and the air inlet faces the dirt-holding cavity.

In some optional embodiments, the first shell is detachably connected to the main body.

In some optional embodiments, the multiple air inlets are annularly arranged at the opening of the dirt-holding cavity.

In some optional embodiments, the suction assembly further includes a rotation module, the rotation module is arranged in the first shell, and the second shell connects to the first shell by the rotation module.

In some optional embodiments, the toilet equipment further includes a control unit, the negative pressure source and the rotation module are both electrically connected to the control unit.

In some optional embodiments, the toilet equipment further comprises a human body sensor, the human body sensor is arranged in the first shell and electrically connected to the control unit.

In some optional embodiments, the toilet equipment further includes an ultraviolet lamp, the ultraviolet lamp is arranged on the surface of the second shell and faces the dirt-holding cavity; and the ultraviolet lamp is electrically connected to the control unit.

In some optional embodiments, the inner surface of the dirt-holding cavity is provided with a reflective coating.

In some optional embodiments, the toilet equipment further includes a condensation particle counter, the condensation particle counter is arranged in the first shell and electrically connected to the control unit.

The beneficial effects of the embodiment of the present utility model are: different from the prior art, the toilet equipment provided by the embodiment of the present utility model suctions the area where aerosols are easily formed in the dirt-holding cavity, and absorbs the small particles mixed with excrement in the air, to effectively reduce the occurrence of aerosol-forming areas in the dirt-holding cavity. It also reduces the occurrence of secondary pollution caused by the inhalation of the suction assembly.

### BRIEF DESCRIPTION OF THE DRAWINGS

In order to illustrate the technical solutions of the embodiments of the present application more clearly, the following brief introduction of the drawings is used to explain the embodiments of the present application. Obviously, the drawings described below are only some embodiments of the present application. For those of ordinary skill in the art, other drawings can also be obtained according to the drawings without any inventive effort.

FIG. 1 is a schematic structural diagram of a toilet equipment provided by the first embodiment of the present invention;

FIG. 2 is a schematic structural diagram of the toilet equipment shown in FIG. 1 from another view, showing the relationship between the turbulent flow in the dirt-holding cavity and the airflow of the suction assembly;

FIG. 3 is a schematic structural diagram of the toilet equipment shown in FIG. 1 when the dirt-holding cavity is open;

FIG. 4 is a schematic block diagram of the flushing assembly of the toilet equipment shown in FIG. 1;

FIG. 5 is a schematic block diagram of the suction assembly of the toilet equipment shown in FIG. 1;

FIG. 6 is a schematic block diagram of each component of the toilet equipment shown in FIG. 1.

FIG. 7 is a schematic diagram of the toilet equipment with an adenosine triphosphate (ATP) luminometer instant bacteria detection device.

### DESCRIPTION OF THE EMBODIMENTS

In order to facilitate the understanding of the present utility model, the present utility model will be described in more detail below with reference to the accompanying drawings and specific embodiments. It should be noted that when an element is referred to as being “fixed to”/“fixed to” another element, it can be directly on the other element, or one or more intervening elements may be present therebetween. When an element is referred to as being “connected” to another element, it can be directly connected to the other element or one or more intervening elements may be present therebetween. The terms “vertical”, “horizontal”, “left”, “right”, “inner”, “outer” and similar expressions used in this specification are for illustrative purposes only.

Unless otherwise defined, all technical and scientific terms used in this specification have the same meaning as commonly understood by one of ordinary skill in the technical field belonging to the present invention. The terms used in the description of the present invention are only for the purpose of describing specific embodiments, and are not used to limit the present invention. As used in this specification, the term “and/or” includes any and all combinations of one or more of the associated listed items.

In addition, the technical features involved in the different embodiments of the present invention described below can be combined with each other as long as there is no conflict with each other.

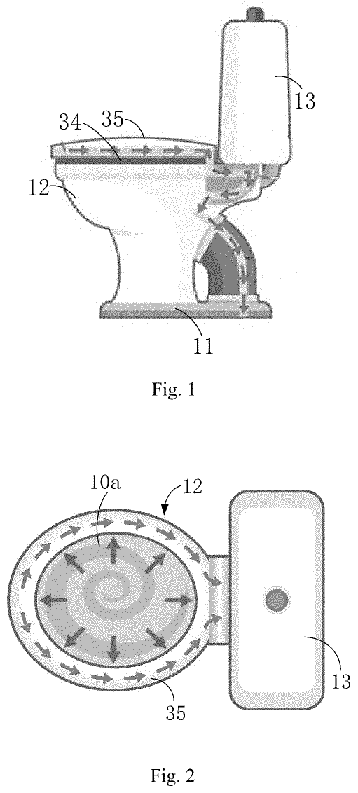

Refer to FIG. 1, FIG. 1 is a schematic structural diagram of a toilet equipment provided by an embodiment of the present utility model. In brevity, the embodiment of the present utility model takes the close stool as a toilet equipment as an example. It can be understood that the toilet equipment described in the embodiments of the present invention is not limited to the toilet, but can also be other toilets except the close stool, such as a squat pan or urinal.

Referring to the example shown in FIG. 1, the toilet equipment includes a main body 10, a flushing assembly 20 and a suction assembly 30. The main body 10 is an installation support structure for the flushing component 20 and the suction assembly 30, and the flushing component 20 and the suction assembly 30 are both arranged on the main body 10. The flushing assembly 20 is accommodated in the main body 10, and the user can press the flushing assembly 20 by himself to clean the excrement of the user in the main body 10, or, during or after the user's excretion process, the flushing assembly 20 can automatically clean the waste. The suction assembly 30 is connected to the main body 10, and the suction assembly 30 can inhale the area of the main body 10 where excrement is stored, so as to reduce generating aerosol in the area.

For explanation, the specific structures of the above-mentioned main body 10, the flushing assembly 20 and the suction assembly 30 will be described in turn with reference to the accompanying drawings. The following embodiments and features of the embodiments may be combined with each other without conflict.

For the above-mentioned main body 10, for example, the toilet equipment is fixedly installed in an immovable toilet. The dirt-holding cavity 10a is a cavity for collecting excrement, the excrement includes but is not limited to solid excrement, liquid excrement and solid-liquid mixed excrement produced by the user. The sewage outlet is located at the bottom of the dirt-holding cavity 10a, and the sewage outlet is connected to external sewage pipes. Flushing by the flushing component 20, the excrement can be discharged out of the dirt-holding cavity 10a through the sewage outlet, so as to keep the dirt-holding cavity 10a clean. It is understood, the toilet equipment can also be installed in a movable toilet. If the movable toilet is inconvenient for the discharge of excrement, the sewage outlet of the main body 10 can be sealed and connected to the sewage collection bag, and the sewage collection bag can collect a certain capacity of excrement.

Referring to the example shown in FIG. 1, the main body 10 includes a base 11, a toilet seat 12 and a water tank 13. The base 11 is the installation support for the toilet seat 12 and the water tank 13. The toilet seat 12 is arranged on the base 11 and is integrally connected with the base 11. The toilet seat 12 is provided with the above-mentioned dirt-holding cavity 10a, and a flush hole connects to the dirt-holding cavity 10a. The water tank 13 is provided with a water storage cavity, and a water inlet connected to the water storage cavity. The water inlet connects to the water pipe. The water storage cavity connects to the flush hole by connecting the pipe. The liquid stored in the water storage cavity can flow into the dirt-holding cavity 10a through the flushing hole under the action of the height difference, so as to clean the dirt-holding cavity 10a. Optionally, the main body 10 is made of ceramic material, that is, the base 11, the toilet seat 12 and the water tank 13 are integrally formed with a ceramic structure.

In order to reduce the residual part of the excrement easily sticking to the cavity wall of the dirt-holding cavity 10a, and improve the cleaning effect of the dirt-holding cavity 10a, optionally, the inner surface of the dirt-holding cavity 10a is provided with a less rough surface with a reflective coating. In order to protect the cavity wall of the dirt-holding cavity 10a from being invaded by bacteria, molds, algae and other microorganisms, further, the reflective coating is a nano-scale antibacterial reflective coating.

The embodiment of the present utility model does not limit the structure of the flushing assembly 20, and it can be a general one that is used in the flush toilet with certain water pressure. Referring to FIG. 2 and FIG. 4, the flushing assembly 20 includes an inlet pipe 21, a mechanical button mechanism 22 and a booster pump 23. One end of the water inlet pipe 21 is connected to the water pipe by the booster pump 23, and the other end of the water inlet pipe 21 connects with the water inlet of the water tank 13. The booster pump 23 is arranged on the pipeline of the water inlet pipe 21 and used to pressurize the liquid in the water inlet pipe 21. The mechanical button mechanism 22 is arranged in the water storage cavity, and the button of the mechanical button mechanism 22 can be exposed on the top of the water tank 13. The switch of the mechanical button mechanism 22 can shut the water inlet when the water storage cavity is fully filled with liquid. When the user presses the button of the mechanical button mechanism, the switch of the mechanical button mechanism 22 is separated from the water inlet hole, so that the liquid stored in the water storage cavity is pumped to the flush hole under the pressurization action of the booster pump 23, and flushed the dirt-holding cavity 10a with certain pressure. By setting the booster pump 23, the liquid entering the dirt-holding cavity 10a can maintain sufficient flushing pressure to ensure that the excrement can be flushed clean. Preferably, the booster pump 23 is a mechanical booster pump 23.

It must be emphasized, that the flushing assembly 20 can be configured into different flushing modes according to the usage situation, for example, gravity flushing mode, pressure-assisted flushing mode, dual flushing mode, single flushing mode, dual cyclone flushing mode, tornado flushing mode, tower flushing mode, dual vortex flush mode, etc.

It is understood, that the booster pump 23 can be adaptively adjusted according to the actual use. In other embodiments of the present utility model, the booster pump 23 may not be provided, and it is only necessary to keep the liquid entering the dirt-holding cavity 10a with sufficient flushing pressure to ensure that the excrement can be washed away.

For the above suction assembly 30, please refer to the example shown in FIG. 5, the suction assembly 30 includes a suction pipe 31, a filter 32 and a negative pressure source 33. The suction duct 31 is provided with an air inlet 31a and an air outlet 31b, the filter element 32 is arranged between the air inlet 31a and the air outlet 31b, and the negative pressure source 33 is connected to the toilet seat 12. The negative pressure source 33 is configured to provide airflow into the suction pipe 31 from the air inlet 31a, and the air inlet 31a is used to inhale the air in the dirt-holding cavity 10a under the action of the airflow of the negative pressure source 33. In such a way, by sucking the area where aerosols are easily formed in the dirt-holding cavity 10a, and adsorbing the small particles mixed with excrement in the air, the aerosols forming area in the dirt-holding cavity 10a is effectively reduced. At the same time, the occurrence of secondary pollution caused by the suction of the suction assembly 30 is also reduced. As an example, the filter 32 is a HEPA filter, and is replaceable, so that the filter 32 can be replaced periodically.

In some usage scenarios, the toilet equipment is installed in a fixed building, and the suction assembly 30 will always be in a working state during the use of the toilet equipment, so as to prevent the aerosol in the dirt-holding cavity 10a from escaping outside the dirt-holding cavity 10a, the air outlet 31b of the suction assembly 30 can be connected with the ventilation system of the building, and a single-way valve is set between the air outlet 31b and the ventilation pipe of the ventilation system, which effectively avoids reverse airflow in the ventilation system.

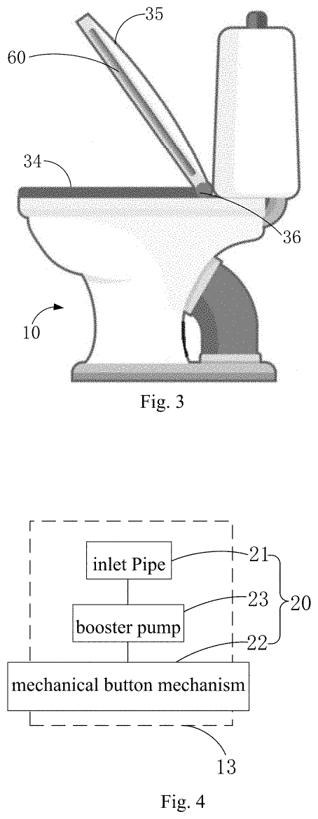

Referring to the example shown in FIG. 3, the suction assembly 30 further includes a first shell 34 and a second shell 35, the first shell 34 is detachably connected to the toilet seat 12, and the first shell 34 is the opening of the dirt-holding cavity 10a. the second shell 35 is rotatably connected to the first shell 34, and the second shell 35 has a first rotating state and a second rotating state relative to the first shell 34. When the shell 35 is in the first rotating state, the opening of the dirt-holding cavity 10a is closed, and when the second shell 35 is in the second rotating state, the opening of the dirt-holding cavity 10a is opened. Wherein, the suction pipe 31 and the negative pressure source 33 are both arranged in the first shell 34, and the air inlet 31a faces the dirt-holding cavity 10a.

It is understood, that the connection method between the first shell 34 and the toilet seat 12 is not limited to the above. The first shell 34 is installed and fixed on the toilet seat 12. In addition, the first shell 34 can be arranged at any position of the toilet seat 12, as long as the second shell 35 can close or open the opening of the dirt-holding cavity 10a. Further, the first shell 34 and the second shell 35 can also be set according to actual use requirements, which are not specifically limited herein.

It should be noted, that the second shell 35 has a first rotational state and a second rotational state relative to the first shell 34. The first rotation state refers to the minimum angle between the second shell 35 and the first shell 34 around the axis of rotation. Then, the opening of the dirt-holding cavity 10a is closed by the second shell 35. The second rotation state refers to the maximum angle between the second shell 35 and the first shell 34 around the axis of rotation. Then, the second shell 35 completely does not cover the cavity of the dirt-holding cavity 10a, and the second shell 35 opens the opening of the dirt-holding cavity 10a. In an actual usage scenario, the second shell 35 can rotate relative to the first shell 34 between the first rotational state and the second rotational state.

In order to reduce the time of inhaling the air from the dirt-holding cavity 10a to the suction pipe 31, further, the number of air inlets 31a is multiple, and multiple air inlets 31a are annularly arranged at the opening of the dirt-holding cavity 10a and they are facing to the opening of the dirt-holding cavity 10a. The multiple air inlets 31a can form a variety of airflow guide directions together, and can be designed for different types and regions of flushing systems, and can set different airflow guide directions. For example, the northern or southern hemispheres provide counterclockwise/clockwise pumping control and guidance directions. In addition, the air inlets 31a are designed with a Pittsburgh seam concept (only allowing airflow to enter the suction pipe 31), so that the suction pipe 31 is not easily blocked by foreign objects, so as to have good suction efficiency.

In order to facilitate the user opening or closing the cavity opening of the dirt-holding cavity 10a, optionally, the suction assembly 30 further includes a rotating module 36. The first shell 34 is rotatably connected. Specifically, the rotation module 36 is a motor or a rotation adjustment mechanism. The user can press the button of the rotation adjustment mechanism to make the second shell 35 rotate from the first rotation state to the second rotation state. When the user presses the button of the rotation adjustment mechanism again, the second shell 35 can be rotated from the second rotation state to the first rotation state. Alternatively, the first shell 34 can be automatically switched between the first rotation state and the second rotation state under the driving of the motor.

Further, the toilet equipment is provided with a control unit 40, and the negative pressure source 33 and the rotation module 36 are both electrically connected to the control unit 40. When the second shell 35 receives the command from the control unit 40 and closes the opening of the dirt-holding cavity 10a, the negative pressure source 33 can increase the suction force under the command of the control unit 40 (the pressure generated by the flushing assembly 20 increases 3-4 times the suction force), the airflow generated by the flushing assembly 20 is immediately sucked away, and the clean air outside the dirt-holding cavity 10a can be automatically sucked into the dirt-holding cavity 10a under the condition of negative pressure in the dirt-holding cavity 10a. Under such an arrangement, the turbulent flow or turbulent flow generated by the flushing assembly 20 during flushing can be effectively improved, and the duration of the process is short, which lasts only 6 to 8 seconds.

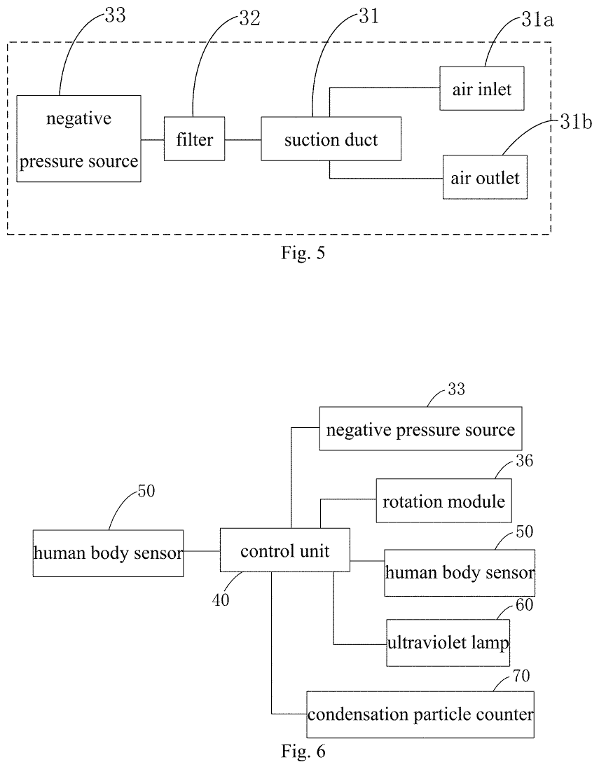

Referring to the example shown in FIG. 6, in order to further facilitate the user opening or closing the opening of the dirt-holding cavity 10a, further, the toilet equipment includes a human body sensor 50, and the human body sensor 50 is arranged on the first shell 34, and the human body sensor 50 is electrically connected to the control unit 40. When the human body sensor 50 senses that the user is using the toilet, the second shell 35 can be automatically opened, and when the human body sensor 50 senses that the user is leaving the toilet, the second shell 35 can be automatically closed.

Referring to the example shown in FIG. 6, in order to further reduce bacteria in the toilet, the toilet equipment includes an ultraviolet lamp 60. The ultraviolet lamp 60 is electrically connected to the control unit 40. When the second shell 35 closes the opening of the dirt-holding cavity 10a, the ultraviolet lamp 60 can be automatically activated, and the ultraviolet light generated by the ultraviolet lamp 60 sterilizes the airtight area enclosed by the dirt-holding cavity 10a and the second shell 35, Since the inner surface of the dirt-holding cavity 10a has a coating with less roughness, the ultraviolet light can be diffusely reflected each part of the area. The duration of the ultraviolet lamp 60 ranges from about 30 seconds to 120 seconds, and a suitable working time can be set for different germs and viruses.

Referring to the example shown in FIG. 6, in order to facilitate real-time detection of the number of aerosols or aerosol particles in the air in the dirt-holding cavity 10a, further, the toilet equipment includes a condensation particle counter 70, and the condensation particle counter 70 is provided in the first shell 34, the condensation particle counter 70 is electrically connected to the control unit 40. The condensation particle counter 70 is used for real-time detection of the number of aerosols or aerosol particles in the air of the dirt-holding cavity 10a. If the detected amount of aerosols in the air exceeds a set threshold, relevant reminder information can be sent out, such as, a warning light can be set on the toilet equipment, and the user can be prompted to deal with the toilet equipment through the warning light, or an alarm can be set in the toilet equipment, and the user can also be prompted to deal with the toilet equipment through the alarm.

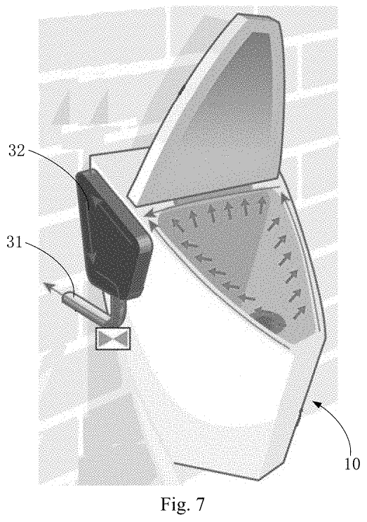

Referring to the example shown in FIG. 7. When the toilet equipment is a urinal, it can also be equipped with an ATP luminometer (adenosine triphosphate—luminometer) instant bacteria detection device. In the bacteria detection mode, the urinal can be detected in 10-15 seconds. Then the test liquid injection pipe of the luminometer will spray the appropriate test liquid to the urinal as the detection medium, and then the condensation particle counter 70 will extend the detection rod to measure the bacteria. When the number of bacteria detected reaches 100,000 RLU or above, it will be alerted by the warning light and the alarm.

The above descriptions are only the embodiments of the present utility model, and are not intended to limit the scope of the patent of the present utility model. Any equivalent structure or equivalent process transformation made by using the contents of the description and drawings of the present utility model, or directly or indirectly applied to other relevant technical fields, shall be included in the scope of patent protection of the present utility model.

1. A toilet equipment, comprising:
a main body, being provided with a dirt-holding cavity for collecting excrement;
a flushing assembly, being arranged in the device body for flushing the dirt-holding chamber; and
a suction assembly, including a suction pipe, a filter, and a negative pressure source; wherein the suction pipe is provided with an air inlet and an air outlet, the air inlet is a slit, the filter is arranged between the air inlet and the air outlet, and the negative pressure source is connected to the main body; the negative pressure source is configured to provide airflow from the air inlet into the suction pipe, and the air inlet inhale the air in the dirt-holding cavity by the airflow of the negative pressure source.

2. The toilet equipment of claim 1, wherein the suction assembly includes a first shell and a second shell; the first shell is connected to the main body, and is located at the opening of the dirt-holding cavity; the second shell is rotatably connected to the first shell and the second shell is set a first rotating state and a second rotating state relative to the first shell; the second shell rotates to the first rotating state to close the opening of the dirt-holding chamber and rotate to the second rotation state to open the opening of the dirt-holding cavity;
the suction pipe and the negative pressure source are both arranged in the first shell, and the air inlet faces the dirt-holding cavity.

3. The toilet equipment of claim 1, wherein the first shell is detachably connected to the main body.

4. The toilet equipment of claim 2, wherein the multiple air inlets are annularly arranged at the opening of the dirt-holding chamber.

5. The toilet equipment of claim 2, wherein the suction assembly further includes a rotation module, the rotation module is arranged in the first shell, and the second shell connects to the first shell by the rotation module.

6. The toilet equipment of claim 2, wherein the toilet equipment further includes a control unit, the negative pressure source and the rotation module are both electrically connected to the control unit.

7. The toilet equipment of claim 2, wherein the toilet equipment further comprises a human body sensor, the human body sensor is arranged in the first shell and electrically connected to the control unit.

8. The toilet equipment of claim 8, wherein the toilet equipment further includes an ultraviolet lamp, the ultraviolet lamp is arranged on the surface of the second shell and faces the dirt-holding cavity; the ultraviolet lamp is electrically connected to the control unit.

9. The toilet equipment of claim 8, wherein the inner surface of the dirt-holding cavity is provided with a reflective coating.

10. The toilet equipment of claim 8, wherein the toilet equipment further includes a condensation particle counter, the condensation particle counter is arranged in the first shell and electrically connected to the control unit.
